(19) United States
(12) Patent Application Publication
(10) Pub. No.: US 2025/0299379 A1
(43) Pub. Date: Sep. 25, 2025

(54) AUGMENTED REALITY CLEANING SYSTEM

(71) Applicant: Dyson Technology Limited, Malmesbury Wiltshire (GB)

(72) Inventors: Matthew Simon GOODLEY, Bristol (GB); Anthony Andrew Buchanan HARKER, Oxford (GB); Joel Alan KNOX, Chippenham (GB)

(21) Appl. No.: 18/863,439

(22) PCT Filed: May 16, 2023
(86) PCT No.: PCT/IB2023/055024

§ 371 Date: Nov. 6, 2024

(30) Foreign Application Priority Data
May 20, 2022 (GB) 2207422.3

(51) Int. Cl. G06T 11/00; A47L 9/28; A47L 11/40; G01S 17/89; G06T 7/70

(52) U.S. Cl. CPC G06T 11/00; A47L 9/2805; A47L 9/2857; A47L 11/4008; A47L 11/4011; G01S 17/89; G06T 7/70; G06T 2207/10016

(57) ABSTRACT

A system is configured to track areas which have been cleaned using a cleaning appliance. The system includes: a location determination module; a processor; and a display component. The location determination module is configured to determine location information indicative of a location of a portion of a surface which is being cleaned by a cleaning appliance at a given time, and to generate a location data signal encoding the location information. The processor is configured to receive the location data signal from the location determination module and to determine, based on the location data signal, the location information, and to generate instructions configured to cause a display component to display a visual representation of the location information.

### TECHNICAL FIELD OF THE INVENTION

The present invention relates to a system for tracking areas which have been cleaned using a cleaning appliance based on location information indicative of a location of the cleaning appliance at a given time. Equivalent methods and computer-implemented methods are also provided.

### BACKGROUND TO THE INVENTION

Currently, when a user is cleaning an area, it is often difficult to keep track of areas that have already been cleaned in the cleaning process. For example, when vacuum cleaning, there is no reliable means of displaying to the user which areas of the floor have and have not been cleaned. This is in part because, in most cases, dust particles are very small, to the point where it is very difficult, if not impossible to spot them with the naked eye. Vacuum cleaners can leave stripes in long-pile carpets that indicate where the vacuum cleaner has been, but this is unreliable, and the problem is exacerbated in areas with hard or smooth surfaces.

This difficulty in keeping track of the areas that have already been cleaned can often lead to a duplication of effort on the user's part and inefficiencies in automated systems. It is therefore desirable to provide an improved means of tracking areas which have been cleaned using a cleaning appliance.

### SUMMARY OF THE INVENTION

Broadly speaking, the present invention relates to methods and systems for tracking areas which have been cleaned using a cleaning appliance based on location information indicative of a location of a portion of a surface which is being cleaned by a cleaning appliance at a given time. Specifically, the system is configured to generate a visual representation of the location information to the user.

More specifically, a first aspect of the present invention provides a system configured to track areas which have been cleaned using a cleaning appliance, the system comprising: a location determination module; a processor; and a display component, wherein: the location determination module is configured to determine location information indicative of a location of a portion of a surface which is being cleaned by a cleaning appliance at a given time; and to generate a location data signal encoding the location information; and the processor is configured to receive the location data signal from the location determination module and to determine, based on the location data signal, the location information; and to generate instructions configured to cause a display component to display a visual representation of the location information.

The cleaning apparatus is preferably configured to clean a surface. The cleaning apparatus may be configured to clean the surface under a user's direction, for example, by cleaning the surface as the user manually moves the appliance across the surface. Alternatively, or in addition, the cleaning appliance may be configured to clean the surface in an automated manner. For example, the cleaning appliance may be configured to move across, and clean, a surface under its own direction by following an automation protocol. In a specific example, the cleaning appliance may be a robotic vacuum cleaner configured to move across a floor surface and clean dust particles from said surface as part of an automated cleaning routine, which may have been defined by a user or automatically based on the environment in which the surface is located.

Preferably, the cleaning appliance is a user operated vacuum cleaner that is configured to clean a surface by removing dust from the surface as the user moves the vacuum cleaner across the surface. However, the cleaning appliance may be any appliance suitable for cleaning or treating a surface, such as: a vacuum cleaner; a wet vacuum cleaner; a wet and dry vacuum cleaner; a polisher; a steam cleaner; a hard surface cleaner or a carpet cleaner.

Put another way, the cleaning appliance is configured to perform some kind of cleaning action, such as vacuuming, dusting, wiping, or the like. In preferred cases, the cleaning action is vacuuming, in which dust particles on the floor are entrained in an airflow which causes them to be removed from the floor by suction and deposited in a receptacle which forms part of the cleaning appliance, which in such an application may be a vacuum cleaner. In some cases, the receptacle may be removable from the vacuum cleaner. During this process, the dust particles move along the airflow path. By its nature as a vacuum cleaner, it will be understood that the vacuum cleaner includes some kind of means for generating a vacuum or negative pressure, thereby generating a suction force which causes air to flow from outside the robotic vacuum cleaner the airflow path. The means for generating a vacuum or negative pressure may be referred to as a vacuum generating component and may comprise a motor. The speed of the motor (in e.g., revolutions per minute) is preferably proportional to, or correlates with, with the suction power. The higher the speed of the motor, the stronger the suction power. The speed of the motor may be controlled by controlling the power supply to the motor, wherein a greater amount of power supplied to the motor gives rise to a greater speed, and vice versa. There may be a plurality of predetermined power levels for the motor, each corresponding to a predetermined motor speed. Preferably, there are three predetermined power levels corresponding to three different motor speeds.

At any given time, the vacuum cleaner may be configured to remove dust particles from a surface, such as the floor. Specifically, the region of the surface, from which the dust particles are removed at the given time, may be the region of floor which is located beneath a cleaning region-defining assembly of the vacuum cleaner. Evidently, the cleaning region-defining assembly is preferably located at a base of the vacuum cleaner (herein, the term “base” is used to refer to a side or surface of the vacuum cleaner which, during a cleaning operation, faces or engages the surface). The cleaning region-defining assembly preferably includes an enclosure having an open base, wherein at least an outer wall of the enclosure defines an edge of a cleaning region.

The enclosure preferably comprises an outer housing having a lower edge which is arranged to face the surface in use. Preferably, the lower edge is arranged to be spaced from the surface when the vacuum cleaner is placed on the surface with the base facing the surface. This spacing ensures that air is able to pass into the enclosure from the outside. In some cases, the enclosure may contain a brush. In use, as the vacuum cleaner moves across the floor, the brush may be configured to disturb or otherwise agitate dust that is located on the surface, thereby causing the dust to be entrained in the moving air, and to pass into the airflow path. In preferred cases, the brush may be configured to rotate in use, improving the extent to which dust particles are disturbed, thereby ensuring that more dust particles can be entrained in the airflow, and can thus be vacuumed up. Such an enclosure may be referred to as a brush bar. The lower edge of the housing of the brush bar may define a generally rectangular cleaning region of the surface from which dust is removed at any given time. This may be referred to herein as a “brush bar area”. Rotation of the brush may be controlled by a motor. The speed of the motor may be controlled by controlling the power supply to the motor, wherein a greater amount of power supplied to the motor gives rise to a greater speed, and vice versa. There may be a plurality of predetermined power levels for the motor, each corresponding to a predetermined motor speed. Preferably, there are three predetermined power levels corresponding to three different motor speeds.

Herein, “airflow path” refers to the route which moving air takes from the outside to the receptacle, e.g., underneath the gap defined by the floor and lower edge of the outer wall of the enclosure/housing, then through the vacuum cleaner into the receptacle. The airflow path preferably includes an air duct which is located in between, and in fluid communication with, both the enclosure and the receptacle.

The first aspect of the invention requires a location determination module configured to determine location information indicative of a location of a portion of a surface which is being cleaned by a cleaning appliance at a given time. Preferably, the location determination module is configured to determine the location information at predetermined time intervals. The time intervals are preferably regular time intervals, meaning that each time interval is the same duration. The time intervals may have a duration appropriate to the application of the invention. For example, a time interval may have a duration of one second, more than one second (such as two second, five second, ten second or more), less than one second (such as half a second, quarter of a second or less). The duration of the time intervals may be configured to provide more or less continuous location monitoring for the cleaning appliance. For example, by reducing the duration of the time intervals to an appropriate amount of time, the location information may be a continuous, or near continuous, set of time series data.

In certain aspects of the invention, the duration of the time intervals may be adjusted based on a movement speed of the cleaning appliance across the surface being cleaned. For example, when the cleaning appliance is moving slowly across the surface, the duration of the time intervals may be increased without significantly degrading the accuracy of the location information, thereby reducing the computational power required by the processor at such times. Further, when the cleaning appliance is moving quickly across the surface, the duration of the time intervals may be decreased in order to improve the accuracy of the location information at such times. The terms “quickly” and “slowly” provided above may be interpreted as meaning “above a predetermined speed threshold” and “below a predetermined speed threshold”, respectively. The speed thresholds may be defined at the point of manufacture, defined by the user or defined automatically by the system based on how the cleaning appliance is used.

By way of a worked example of the system in use, the user may begin cleaning a surface by positioning the cleaning appliance at a first location on the surface at a first point in time. The user may also activate the system of the invention, or the system may activate automatically when the cleaning appliance is in use. The location determination module of the system determines location information indicative of the first location on the surface where the cleaning appliance is located at that first point in time. The user may then move the cleaning appliance across the surface to effect the cleaning of said surface. As the user moves the cleaning appliance, the cleaning appliance will arrive at a second location on the surface at a second point in time, the first and second points in time being separated by a single time interval. At the second point in time, or after a time interval has elapsed, the location determination module may be configured to determine location information indicative of the second location on the surface where the cleaning appliance is located at that second point in time. This process may be repeated across a plurality of locations and time intervals as the surface is being cleaned, thereby generating a series of individual location data signals illustrating the changing position of the cleaning appliance on the surface over time.

As outlined above, the cleaning appliance may comprise a cleaning component which defines the portion of the surface being cleaned at any given time. Returning to the example of the cleaning appliance being a vacuum cleaner, the cleaning component may be the base portion of the vacuum cleaner, the enclosure of which defines the cleaning area, or the portion of the surface being cleaned, being cleaned by the vacuum cleaner. In a further example, the cleaning appliance may be a steam cleaner with a steam head, the steam head being the component from which steam is emitted for cleaning the surface, wherein the steam head defines the portion of the surface being cleaned at any given time. The location determination module may be configured to determine the location of the cleaning component, such as the vacuum base portion or the steam head, within its surroundings, and to generate the location information based on the location of the cleaning component within its surroundings. Put another way, rather than determining location information for the entire cleaning appliance, the location determination module may determine location information for the cleaning component of the cleaning appliance, thereby improving the accuracy of the tracking of the areas that have been cleaned by the cleaning appliance.

The first aspect of the invention also requires a processor configured to receive the location data signal from the location determination module and to determine, based on the location data signal, the location information. The processor is further configured to generate instructions configured to cause a display component to display a visual representation of the location information. Preferably, the instructions are configured to cause the display component to display the visual representation of the location information in real-time. The term “real-time” may be interpreted as meaning that the visual representation of the location information is displayed at the same time or substantially the same time as the cleaning appliance is at the displayed location. In other words, the term “real-time” may be interpreted as meaning that the visual representation of the location information is displayed during the actual time during which the cleaning of the surface. For example, the visual representation of the location information may be displayed at the display component within a sufficiently short amount of time, such as less than a second, so that the visual representation of the location information is displayed to the user virtually immediately as feedback to the cleaning process. Put another way, as the cleaning appliance is moved across the surface, and correspondingly as the location data signals generated by the location determination module are being updated, the instructions generated by the processor may be updated to cause the display to show a visual representation of the location information as it is being updated.

The display component for showing the visual representation of the location data may be comprised in a device separate from the cleaning appliance or the display component may be comprised in the cleaning appliance itself. According to an aspect of the invention, the system may comprise a mobile device comprising the location determination module; the processor; and the display component. Preferably, the mobile device is mountable to the cleaning appliance, such that when a user is using the cleaning appliance to clean the surface, the display component of the mobile device, and so the visual representation of the location data, is visible to the user. The mobile device may comprise one or more of: a smartphone; a touchscreen device; a tablet device; a smartwatch or the like. According to another aspect of the invention, the cleaning appliance may comprise: the location determination module; the processor; and the display component. Once again, the display component may be provided on the cleaning appliance such that when a user is using the cleaning appliance to clean the surface, the display component of the cleaning appliance, and so the visual representation of the location data, is visible to the user.

We now discuss ways in which the location information may be determined by the location determination module.

In a first example, the system further comprises a camera configured to capture video data of its surroundings. In this example, the location determination module is configured to determine the location information based on at least the captured video data. The term “video data” may comprise a time series of individual frames captured by the camera at each time interval or a continuous stream of image frames. In other words, the video data may comprise a series of individual images captured by the camera. The camera may be adapted to capture a single image at every time interval. Alternatively, the camera may capture a continuous stream of images, but only single frames are selected for transfer to the location determination module at each time interval. The camera may be configured to operate in the visible spectrum of light or in any other appropriate spectrum of light, such as infrared.

The camera may be configured to capture the video data at predetermined time intervals. The time intervals are preferably regular time intervals, meaning that each time interval is the same duration. The time intervals may have a duration appropriate to the application of the invention. For example, a time interval may have a duration of one second, more than one second (such as two second, five second, ten second or more), less than one second (such as half a second, quarter of a second or less). The duration of the time intervals may be configured to provide more or less continuous location monitoring for the cleaning appliance. For example, by reducing the duration of the time intervals to an appropriate amount of time, the video data may be a continuous, or near continuous, set of time series data.

In certain aspects of the invention, the duration of the time intervals may be adjusted based on a movement speed of the cleaning appliance across the surface being cleaned. For example, when the cleaning appliance is moving slowly across the surface, the duration of the time intervals may be increased without significantly degrading the accuracy of the location information, thereby reducing the computational power required by the processor at such times. Further, when the cleaning appliance is moving quickly across the surface, the duration of the time intervals may be decreased in order to improve the accuracy of the location information at such times. The terms “quickly” and “slowly” provided above may be interpreted as meaning “above a predetermined speed threshold” and “below a predetermined speed threshold”, respectively. The speed thresholds may be defined at the point of manufacture, defined by the user or defined automatically by the system based on how the cleaning appliance is used.

By way of a worked example of the system in use, the user may begin cleaning a surface by positioning the cleaning appliance at a first location on the surface at a first point in time. The user may also activate the system of the invention, or the system may activate automatically when the cleaning appliance is in use. The camera may be configured to capture video data from the first location and the location determination module determines location information indicative of the first location on the surface where the cleaning appliance is located at that first point in time based on the captured video data. The user may then move the cleaning appliance across the surface to effect the cleaning of said surface. As the user move the cleaning appliance, the cleaning appliance will arrive at a second location on the surface at a second point in time, the first and second points in time being separated by a single time interval. At the second point in time, or after a time interval has elapsed, the camera may be configured to capture further video data and the location determination module determines location information indicative of the second location on the surface where the cleaning appliance is located at that second point in time based on the further video data. This process may be repeated across a plurality of locations and time intervals as the surface is being cleaned, thereby generating a series of individual location data signals illustrating the changing position of the cleaning appliance on the surface over time.

Preferably, the display component is configured to display the captured video data and the instructions are configured to cause display component to superimpose the visual representation of the location information over the display of the captured video data, such that each locus of the visual representation of the location information is superimposed on the corresponding locus of the captured video data. The term “corresponding locus” may be interpreted as meaning that a given point in real space (i.e., the surroundings of the cleaning appliance) has the same locus position in both the captured video data and the visual representation of the location information. Put another way, a locus in the captured video data may correspond to a locus in the visual representation of the location information, and both loci may correspond to the same point in real space.

The visual representation of the location data may take different forms according to various aspects of the invention. For example, the visual representation of the location data may include a coordinate, or a distance moved from an origin point, which may be defined at the point of activation of the cleaning appliance for cleaning the surface. Alternatively, the user may define, or redefine, the origin point manually. For example, the user may define the origin point when they begin to clean a first surface with the cleaning appliance and then redefine the origin point when they begin to clean a second, different, surface. In a practical example, this may occur as the user moves from room to room.

In a further example, the visual representation of the location data may include one or more colours for representing the location of the cleaning apparatus on the surface. In this case, a parameter of the colour may change as the location of the cleaning apparatus moves across the surface being cleaned. The parameter of the colour may comprise one or more of: opacity; hue; saturation; brightness; and the like. For example, where the visual representation of the location data includes a single colour, the colour may become more opaque, more saturated and/or brighter as the cleaning appliance passes over a given position on the surface being cleaned one or more times, meaning that an opaque, saturated and/or bright colour on the display may be indicative of a clean area of the surface. Alternatively, again where the visual representation of the location data includes a single colour, the colour may become less opaque, less saturated and/or darker as the cleaning appliance passes over a given position on the surface being cleaned one or more times, meaning that a translucent, unsaturated and/or dark colour on the display may be indicative of a clean area of the surface. In a further example, where the visual representation of the location data includes multiple colours, the hue of the colour may change as the cleaning appliance passes over a given position on the surface being cleaned one or more times, meaning that a given colour, which may be predetermined or set by the user, may be indicative of a clean area of the surface.

In a further example, the visual representation of the location data may include a visual pattern for representing the location of the cleaning apparatus on the surface. In this case, a parameter of the pattern may change as the location of the cleaning apparatus moves across the surface being cleaned. The parameter of the pattern may comprise one or more of: an opacity; a size; an orientation; a repetition of the pattern; a colour (which may include the sub-parameters of hue, brightness and saturation discussed above); and the like. For example, when the user initiates the cleaning appliance, the entire surface may be assigned a given pattern and as the cleaning appliance moves across the surface to clean the surface, the pattern may change or be removed. In a specific example, the visual representation of the location data may show a pattern fading (i.e., reducing in opacity) as the cleaning device moves over a given location one or more times.

As described above, where the system further comprises a camera to capture video data of the surroundings of the cleaning appliance, the visual representation of the location information, such as those visual representations discussed above, may be superimposed onto the captured video data.

Taking the example of a vacuum cleaner as a cleaning appliance for cleaning a floor, the camera may be mounted such that the field of view of the camera includes the cleaning head of the vacuum cleaner and at least the immediate surrounding of the cleaning head. The field of view and the focal length of the lens of the camera may be selected according to the cleaning appliance being used and the surface being cleaned. The display component may be mounted in a position that can be easily viewed by the user, such as near the handle of the cleaning appliance.

When the vacuum cleaner is first initialized in preparation for cleaning the surface, the display component may show the video data being captured by the camera and the visual representation of the location data superimposed thereon. In a particular example, the location data may be a colour or pattern to indicate where the cleaning head of the vacuum cleaner has been in contact with the surface being cleaned. In such an example, when the vacuum cleaner is first initialized in preparation for cleaning the surface, the display component may show only the captured video data. When the user then moves the vacuum cleaner across the surface to begin cleaning, the visual representation of the location data may be generated and superimposed on the captured video data as a coloured, or patterned, path showing where the cleaning head has been. In particular, at each point the camera captures video data of the surroundings of the cleaning apparatus, the location determination module may determine location data indicative of location of the portion of the surface which is being cleaned by the cleaning appliance at that given time and a visual representation (i.e., a colour or a pattern) may be generated and superimposed on the video data for display to the user. In this way, over time and as the cleaning appliance moves across the surface, the user will be presented with a tracked record of the positions occupied by the cleaning appliance since the cleaning process began.

Alternatively, when the vacuum cleaner is first initialized in preparation for cleaning the surface, the display component may show the captured video data with a colour or pattern layer provided over the entire surface to be cleaned. When the user then moves the vacuum cleaner across the surface to begin cleaning, the visual representation of the location data may be generated and superimposed on the captured video data as a clear path in the coloured or patterned layer showing where the cleaning head has been since the cleaning process began.

When cleaning a surface, particularly when cleaning a surface such as a carpet with a vacuum cleaner, it is often desirable to perform multiple passes over the surface with the cleaning appliance in order to ensure the surface has been cleaned sufficiently thoroughly. The present invention may provide a means of tracking multiple passes over a surface with the cleaning appliance as follows.

As described above, when the user then moves the vacuum cleaner across the surface to begin cleaning, the visual representation of the location data may be generated and superimposed on the captured video data as a coloured, or patterned, path showing where the cleaning head has been. The user may then move the vacuum cleaner such that the subsequent path of the cleaning head at least partially overlaps the initial path marked by the visual representation of the location data, for example by first pushing the vacuum cleaner away from themselves and then pulling the vacuum cleaner back along the same path. In this case, the visual representation of the location data in the overlapping region may be altered to indicate that the cleaning appliance has been passed over this region of the surface multiple times. For example, the visual representation of the location data may be a colour having an opacity of 20%. Accordingly, on the first pass of the cleaning appliance over a portion of the surface, the visual representation will show a coloured path with a 20% opacity. When the user next moves the cleaning appliance over this region, such that the cleaning head of the cleaning appliance passes over the existing coloured path, the visual representation of this next pass of the cleaning appliance may simply be added onto the existing visual representation, meaning that there will be a portion of the visual representation having a 40% opacity indicated where two passes of the cleaning appliance have been performed. This may be repeated until 100% opacity of the visual representation is reached, which may indicate that the desired number of passes of the cleaning appliance has been fully achieved. In this example, the user may adjust the opacity of the visual representation in order to reflect the desired number of passes of the cleaning appliance to be achieved when cleaning the surface.

Alternatively, or in addition, to the opacity of the visual representation, any other suitable parameter of the visual representation may be adjusted with each pass of the cleaning appliance to indicate the number of passes performed by the cleaning appliance. For example, when the visual representation comprises a colour to be superimposed on the captured video data, multiple passes of the cleaning appliance over a portion of the surface may be indicated by an increase/decrease in saturation, a change in hue and/or an increase/decrease in brightness of the colour of the visual representation.

In a further aspect, the system further comprises a light detection and ranging (LiDAR) unit configured to capture mapping data of its surroundings. In this example, the location determination module is configured to determine the location information based on at least the captured mapping data.

A LiDAR unit is a component for determining ranges, or distances, between the unit and another object. A LiDAR unit functions by generating a beam of light, preferably using a laser, and targeting the light at an object or a surface. The LiDAR unit is adapted to detect the light reflected by the object and to measure the time taken for the light to travel from the LiDAR unit to the object and back, which may be referred to as a time-of-flight measurement. Based on the time-of-flight measurement and the known speed of light, the LiDAR unit may determine a distance, or range, between the LiDAR unit and an object or surface reflecting the emitted light. By performing a number of measurements across the environment, for example by scanning the laser over the surroundings of the LiDAR unit, it is possible to map the layout of an area. The accuracy of this mapping may be improved further by repeating the above process with the LiDAR unit from multiple locations within the environment.

A LiDAR unit may include one or more of the following components. The LiDAR unit may comprise a laser, a sensor and an actuated mirror. The lasers may be configured to emit light in a wavelength range of 500 nm to 1600 nm, and preferably in the range of 600 nm to 1000 nm. The laser may be power-limited in order to render the laser eye-safe for the user. The laser may be operated in a pulsed manner or a continuous manner according to the application of the cleaning appliance. Preferably, the laser is a 600 nm to 1000 nm laser operated in a pulsed manner. The pulse frequency may be selected according to the application of the cleaning appliance. For example, the pulse frequency may be 1 Hz, more than 1 Hz (such as 2 Hz, 5 Hz, 10 Hz, 100 Hz or more) or less than 1 Hz (such as 0.5 Hz, 0.25 Hz or less). The pulse frequency may be configured to provide more or less continuous location monitoring for the cleaning appliance. For example, by increasing the pulse frequency to an appropriate frequency the captured mapping data, and so the location information, may be a continuous, or near continuous, set of time series data.

In certain aspects of the invention, the pulse frequency may be adjusted based on a movement speed of the cleaning appliance across the surface being cleaned. For example, when the cleaning appliance is moving slowly across the surface, the pulse frequency may be decreased without significantly degrading the accuracy of the location information, thereby reducing the computational power required by the processor at such times. Further, when the cleaning appliance is moving quickly across the surface, the pulse frequency may be increased in order to improve the accuracy of the location information at such times. The terms “quickly” and “slowly” provided above may be interpreted as meaning “above a predetermined speed threshold” and “below a predetermined speed threshold”, respectively. The speed thresholds may be defined at the point of manufacture, defined by the user or defined automatically by the system based on how the cleaning appliance is used.

By way of a worked example of the system in use, the user may begin cleaning a surface by positioning the cleaning appliance at a first location on the surface at a first point in time. The user may also activate the system of the invention or the system may activate automatically when the cleaning appliance is in use. The LiDAR unit may be configured to perform one or more measurements to capture the mapping data and the location determination module of the system determines location information indicative of the first location on the surface where the cleaning appliance is located at that first point in time, based on said mapping data. The user may then move the cleaning appliance across the surface to effect the cleaning of said surface. As the user moves the cleaning appliance, the cleaning appliance will arrive at a second location on the surface at a second point in time, the first and second points in time being separated by a single time interval defined by the pulse frequency of the laser of the LiDAR unit. At the second point in time the location determination module determines location information indicative of the second location on the surface where the cleaning appliance is located at that second point in time based on the captured mapping data from the LiDAR unit captured at the second point in time. This process may be repeated across a plurality of locations and time intervals as the surface is being cleaned, thereby generating a series of individual mapping data sets, and so location data signals, illustrating the changing position of the cleaning appliance on the surface over time.

The laser and the actuated mirror may be arranged such that the generated beam of light hits the actuated mirror, which is adapted to direct the laser beam into the surroundings of the LiDAR unit. An actuated mirror is a mirror, i.e., a reflective surface, which can be moved by an actuation means, such as an electric motor. Preferably, the actuated mirror is configured to rotate about at least one axis and in some cases, about two orthogonal axes. The actuated mirror may comprise any reflective surface suitable for reflecting the laser beam, such as a plane mirror, a multi-faceted mirror, a prism and the like. The actuation means may comprise any actuator suitable for causing the mirror to move, and in particular, to rotate about an axis. For example, the actuator may an electric motor, a stepped electric motor, a microelectromechanical machine and the like.

The sensor of the LiDAR unit may be any sensor suitable for detecting the reflected light. Preferably, the sensor is a photosensor, or a photodetector, that is sensitive to the wavelengths of light generated by the laser, for example, 600 nm to 1000 nm. The photosensor may be a solid-state photodetector, such as a photodiode or an avalanche photodiode, or a photomultiplier.

The LiDAR unit may also comprise a processing unit adapted to determine the time-of-flight of the reflected laser beam detected by the sensor and to derive the range, or distance, of the point of reflection from the LiDAR unit. Alternatively, this function may be performed by the location determination module or the processor of the system of the invention.

The LiDAR unit may be mounted on the cleaning head of the cleaning appliance to determine the distance of the cleaning head from objects or surfaces in the surroundings of the cleaning head. Alternatively, the LiDAR unit may be mounted on the cleaning appliance such that the cleaning head of the cleaning appliance in within the field of view of the LiDAR unit. In this case, the known distance to the cleaning head may be used to determine the distance between the cleaning head and an objects or surfaces in the surrounding environment using an appropriate trigonometric function.

The LiDAR unit described above may be used in conjunction with the camera arrangement described above. For example, the captured mapping data and the captured video data may be utilized in conjunction with each other by the location determination module to determine the location information. In particular, the captured mapping data may be used to provide distance measurements to objects or surfaces identified in the captured video data, thereby improving the accuracy of the determined location information and so improving the accuracy of tracking the surfaces cleaned by the cleaning appliance.

In a further aspect, system further comprises an inertial measurement unit (IMU) configured to detect changes in motion and orientation of the cleaning appliance and to generate IMU data in response to the detection. In this example, the location determination module is configured to determine the location information based on at least the IMU data. The IMU may comprise one or more components for detecting changes in motion and orientation of the cleaning appliance. For example, the IMU may comprise an accelerometer, which may be used to detect an acceleration of the cleaning appliance in a given direction. Further, the accelerometer may be configured to determine the orientation of the cleaning appliance by measuring the action of gravity on the accelerometer. Alternatively, or in addition, the IMU may comprise a gyroscope sensor. The gyroscope sensor may be adapted to measure the orientation of the cleaning appliance. The orientation of the cleaning appliance may be measured in any number of directions or planes. For example, the orientation may be measured in a Cartesian coordinate system having three orthogonal axes. Alternatively, the orientation may be measured as pitch, yaw and roll, which may be defined in relation to the position the cleaning appliance was in when first activated or in relation to a predefined reference position. The IMU may contain any number of accelerometers and/or gyroscopes. For example, the IMU may contain a single accelerometer or gyroscope, an accelerometer and a gyroscope, three accelerometers (each arranged to measure acceleration of the cleaning appliance in one of three orthogonal directions) and the like. The IMU may be located at any suitable position on the cleaning appliance. For example, the IMU may be located in the cleaning head of the cleaning appliance, meaning that the IMU data would relate directly to the motion and/or orientation of the cleaning head as it moves across the surface being cleaned.

The IMU data may be used to determine the location information as follows. When the cleaning appliance is first initiated, the IMU unit may be activated and a reference set of IMU data taken when the cleaning appliance is at rest. When the user moves the cleaning appliance to begin the cleaning process, the IMU unit will detect the acceleration of the cleaning appliance in a given direction. Based on the acceleration signals and the time between changes in acceleration, the IMU unit, or the location determination module, may determine the distance moved by the cleaning appliance across the surface being cleaning. Accordingly, the location determination module may track the movements of the cleaning appliance over the surface being cleaned.

The IMU unit may be configured to capture the location IMU data at predetermined time intervals. The time intervals are preferably regular time intervals, meaning that each time interval is the same duration. The time intervals may have a duration appropriate to the application of the invention. For example, a time interval may have a duration of one second, more than one second (such as two second, five second, ten second or more), less than one second (such as half a second, quarter of a second or less). The duration of the time intervals may be configured to provide more or less continuous location monitoring for the cleaning appliance. For example, by reducing the duration of the time intervals to an appropriate amount of time, the IMU data may be a continuous, or near continuous, set of time series data.

In certain aspects of the invention, the duration of the time intervals may be adjusted based on a movement speed of the cleaning appliance across the surface being cleaned. For example, when the cleaning appliance is moving slowly across the surface, the duration of the time intervals may be increased without significantly degrading the accuracy of the location information, thereby reducing the computational power required by the processor at such times. Further, when the cleaning appliance is moving quickly across the surface, the duration of the time intervals may be decreased in order to improve the accuracy of the location information at such times. The terms “quickly” and “slowly” provided above may be interpreted as meaning “above a predetermined speed threshold” and “below a predetermined speed threshold”, respectively. The speed thresholds may be defined at the point of manufacture, defined by the user or defined automatically by the system based on how the cleaning appliance is used.

By way of a worked example of the system in use, the user may begin cleaning a surface by positioning the cleaning appliance at a first location on the surface at a first point in time. The user may also activate the system of the invention or the system may activate automatically when the cleaning appliance is in use. The IMU unit may be configured to capture a reference set of IMU data of the cleaning appliance at rest and the location determination module of the system determines location information indicative of the first location on the surface where the cleaning appliance is located at that first point in time based on the reference set of IMU data. The user may then move the cleaning appliance across the surface to effect the cleaning of said surface. As the user moves the cleaning appliance, the cleaning appliance will arrive at a second location on the surface at a second point in time, the first and second points in time being separated by a single time interval. At the second point in time, or after a time interval has elapsed, the IMU unit captures further IMU data and the location determination module determines location information indicative of the second location on the surface where the cleaning appliance is located at that second point in time based on the further IMU data. This process may be repeated across a plurality of locations and time intervals as the surface is being cleaned, thereby generating a series of individual location data signals illustrating the changing position of the cleaning appliance on the surface over time.

The IMU unit described above may be used in conjunction with the camera described above and/or the LiDAR unit described above. For example, the captured IMU data and the captured mapping data and/or the captured video data may be utilized in conjunction with each other by the location determination module to determine the location information. In particular, the captured IMU data may be used to provide motion and/or orientation information on the cleaning head of the cleaning appliance, which may be used to inform how the perspective of object or surfaces in the view of the captured video data and/or captured mapping data may have changes, thereby improving the accuracy of the determined location information and so improving the accuracy of tracking the surfaces cleaned by the cleaning appliance.

According to an aspect of the invention, the processor may be configured to determine one or more operating characteristics of the cleaning appliance, wherein the instructions are further configured to cause the display a visual representation of the operating characteristic of the cleaning appliance. Preferably, the one or more operating characteristics comprise one or more of: motor speed; mode of operation; stroke speed; speed of the cleaning appliance relative to the surface being cleaned; a multiple pass count; and data relating to particles collected by the cleaning appliance, which comprise one or more of: particle weight; particle size; and particle type. The visual representation of the operating characteristic of the cleaning appliance may be displayed by the display component in conjunction with the visual representation of the location information. For example, the visual representation of the operating characteristic of the cleaning appliance may be overlaid over the visual representation of the location information or displayed in a separate window on the display component. Alternatively, the visual representation of the operating characteristic of the cleaning appliance may be displayed on a separate display component to the display component showing the visual representation of the location information.

In the case where the cleaning appliance comprises multiple cleaning modes, the visual representation of the operating characteristic of the cleaning appliance may include the current cleaning mode. The visual representation of the operating characteristic of the cleaning appliance may also include the other available cleaning modes in a different visual arrangement to the current cleaning mode in order to highlight which mode the cleaning appliance is currently whilst still displaying all, or some, of the available modes to the user. As described above, the visual representation of the location information may provide an indication of when the same portion of surface has been cleaned by the cleaning appliance multiple times, or in multiple passes. The visual representation of the operating characteristic of the cleaning appliance may include a numerical count of the number of times an area under to the cleaning head of the cleaning appliance has been cleaned, or passed over, which may be referred to as a multiple pass count.

The cleaning appliance may comprise one or more sensors to detect further operating parameters of the cleaning appliance. For example, if the cleaning appliance comprises a motor, such as a motor for driving a vacuum generating component of a vacuum cleaner, the cleaning appliance may comprise a rotation sensor to detect the motor speed. Similarly, if the cleaning appliance comprises a rotating component, such as a rotating brush head or a rotating polishing head, the cleaning appliance may comprise a rotation sensor to detect the stroke speed of the rotating component. Further, the cleaning appliance may comprise a speed sensor for detecting the speed of the cleaning appliance relative to the surface being cleaned. The speed sensor may be a mechanical speed sensor or an optical speed sensor.

Further, the operating parameters of the cleaning appliance may comprise data relating to particles collected by the cleaning appliance. Preferably, the data relating to particles collected by the cleaning appliance comprise one or more of: particle weight; particle size; and particle type. The cleaning appliance may comprise a piezoelectric sensor adapted to generate a plurality of electrical signals in response to a respective plurality of vibrations, each vibration caused by a dust particle striking a detection region of the cleaning appliance.

The piezoelectric sensor preferably comprises a piezoelectric crystal. It will be understood by the skilled person that a piezoelectric crystal has the property that an electrical charge accumulates in the material in response to applied mechanical stress. This means that a voltage may be generated in response to an impact giving rise to a vibration in the piezoelectric crystal. Thus, the electrical signal may be in the form of a voltage signal, though equivalently, a current signal or power signal could also be used. The electrical signal preferably comprises a plot of the change in electrical property with time (or comprises data representing this, e.g., by sampling the voltage across the piezoelectric signal at a plurality of time points). Preferably, a high sampling rate is used, at least 1,000 measurements per second, more preferably at least 5,000 measurements per second. More preferably still, the sampling rate is at least 10,000 measurements per second, and even more preferably around 15,000 measurements per second.

The particle size may be displayed as particle size classes. The particle size classes may comprise one or more of the following: ultrafine dust particles, fine dust particles, medium dust particles, and coarse dust particles. The table below illustrates ranges for the upper and lower bounds of the particle size in each of these classes.

| Class | Lower bound (μm) | Upper bound (μm) |
|---|---|---|
| Ultrafine | 5 to 15 | 45 to 135 |
| Fine | 45 to 135 | 90 to 270 |
| Medium | 90 to 270 | 250 to 750 |
| Coarse | 250 to 750 | 1000 to 3000 |

Of course, in each case, the lower bound must be lower than the higher bound. In a preferred case, the following upper and lower bounds may be used.

| Class | Lower bound (μm) | Upper bound (μm) |
|---|---|---|
| Ultrafine | 10 | 90 |
| Fine | 90 | 180 |
| Medium | 180 | 500 |
| Coarse | 500 | 2000 |

Herein, the term “dust particle size” is defined in terms of an industry standard. Specifically, dolomite particles are used to define “particle size”. It is assumed that particles are spherical in nature and have an average density of 2.7 g/cm³. The term “particle size” refers to the diameter of such a particle according to this definition. This in line with industrial standard IEC-60312 relating to vacuum cleaners for household use.

It will be appreciated that by monitoring the piezoelectric signals over time, the number of particles by weight cleaned by the cleaning apparatus may be determined.

The cleaning apparatus may further comprise a sensor apparatus adapted to determine the type of particles being cleaned by the cleaning apparatus. For example, the sensor apparatus may comprise an optical sensor for determining the type of particles being cleaned by the cleaning apparatus, such as a spectrometer or a camera, which may identify the particle type by image recognition.

The examples given above have been described in the context of a single cleaning apparatus. However, the system may be adapted to function with a plurality of cleaning appliances in order to track the areas which have been cleaned using each cleaning appliance. For example, a robotic vacuum cleaner may automatically clean a floor surface, but due to pathing constraints of the robotic vacuum cleaner, a portion of the floor (such as at the edge of the room) may not have been cleaned by the robotic vacuum cleaner. The robotic vacuum cleaner may comprise some or all of the systems described above in order to track which areas of the floor surface it has cleaned. This information may be transferred to a second cleaning appliance, such as a user operated vacuum cleaner, and the visual representation of the location information may include an indication of the portions of the surface that have already been cleaned by the robotic vacuum cleaner. The user may then use this information to direct the second cleaning appliance to complete the cleaning of the surface in a more efficient manner. The visual representation of the location information may be different for each cleaning appliance, or it may be the same. The visual representation of the location information for each cleaning appliance may be shown simultaneously on the display component, or it may be shown selectively to the user, for example by the user selecting which cleaning appliance(s) they wish to view.

The first aspect of the invention focuses on a system for tracking areas which have been cleaned using a cleaning appliance. A corresponding second aspect of the invention provides a method for tracking areas which have been cleaned using a cleaning appliance, the method comprising:
determining, by a location module, location information indicative of a location of a portion of a surface which is being cleaned by a cleaning appliance at a given time;
generating a location data signal encoding the location information; determining, by a processor, the location information based on the location data signal; and generating instructions configured to cause a display component to display a visual representation of the location information. It will be readily appreciated that methods according to the second aspect of the invention achieve the same technical effects as the system of the first aspect of the invention.

Optional features of the first aspect of the invention apply equally well to the second aspect of the invention, except where clearly incompatible, or where context clearly dictates otherwise. Various optional features are set out explicitly below, but it should be noted that the features set out previously still apply.

The method may further comprise, by way of the location determination module, determining the location information at predetermined time intervals. The time intervals are preferably regular time intervals, meaning that each time interval is the same duration. The time intervals may have a duration appropriate to the application of the invention. For example, a time interval may have a duration of one second, more than one second (such as two second, five second, ten second or more), less than one second (such as half a second, quarter of a second or less). The duration of the time intervals may be configured to provide more or less continuous location monitoring for the cleaning appliance. For example, by reducing the duration of the time intervals to an appropriate amount of time, the location information may be a continuous, or near continuous, set of time series data.

In certain aspects of the invention, the duration of the time intervals may be adjusted based on a movement speed of the cleaning appliance across the surface being cleaned. For example, when the cleaning appliance is moving slowly across the surface, the duration of the time intervals may be increased without significantly degrading the accuracy of the location information, thereby reducing the computational power required by the processor at such times. Further, when the cleaning appliance is moving quickly across the surface, the duration of the time intervals may be decreased in order to improve the accuracy of the location information at such times. The terms “quickly” and “slowly” provided above may be interpreted as meaning “above a predetermined speed threshold” and “below a predetermined speed threshold”, respectively. The speed thresholds may be defined at the point of manufacture, defined by the user or defined automatically by the system based on how the cleaning appliance is used.

By way of a worked example of the system in use, the user may begin cleaning a surface by positioning the cleaning appliance at a first location on the surface at a first point in time. The user may also activate the system of the invention, or the system may activate automatically when the cleaning appliance is in use. The location determination module of the system determines location information indicative of the first location on the surface where the cleaning appliance is located at that first point in time. The user may then move the cleaning appliance across the surface to effect the cleaning of said surface. As the user move the cleaning appliance, the cleaning appliance will arrive at a second location on the surface at a second point in time, the first and second points in time being separated by a single time interval. At the second point in time, or after a time interval has elapsed, the location determination module determines location information indicative of the second location on the surface where the cleaning appliance is located at that second point in time. This process may be repeated across a plurality of locations and time intervals as the surface is being cleaned, thereby generating a series of individual location data signals illustrating the changing position of the cleaning appliance on the surface over time.

The method may further comprise obtaining one or more of: video data, by way of a camera as described above; mapping data, by way of a LiDAR unit as described above; and IMU data, by way of an IMU unit as described above. The location determination module may be adapted to determine the location data based on the captured video data, captured mapping data and/or the captured IMU data.

The method may further comprise generating instruction to cause the display component to display the visual representation of the location information in real-time. The term “real-time” may be interpreted as meaning that the visual representation of the location information is displayed at the same time as the cleaning appliance is at the displayed location. Put another way, as the cleaning appliance is moved across the surface, and correspondingly as the location data signals generated by the location determination module are being updated, the instructions generated by the processor may by updated to cause the display to show a visual representation of the location information as it is being updated.

As described above, the method may comprise capturing video data of the surroundings of the cleaning appliance by way of a camera. The term “video data” may comprise a time series of individual frames captured by the camera at each time interval or a continuous stream of image frames. In other words, the video data may comprise a series of individual images captured by the camera. The camera may be adapted to capture a single image at every time interval. Alternatively, the camera may capture a continuous stream of images, but only single frames are selected for transfer to the location determination module at each time interval. The camera may be configured to operate in the visible spectrum of light or in any other appropriate spectrum of light, such as infrared.

The method may further comprise displaying, by way of a display component, the captured video data and superimposing the visual representation of the location information over the display of the captured video data, such that each locus of the visual representation of the location information is superimposed on the corresponding locus of the captured video data. The term “corresponding locus” may be interpreted as meaning that a given point in real space (i.e., the surroundings of the cleaning appliance) has the same locus position in both the captured video data and the visual representation of the location information. Put another way, a locus in the captured video data may correspond to a locus in the visual representation of the location information, and both loci may correspond to the same point in real space.

The visual representation of the location data may take different forms according to various aspects of the invention. For example, the visual representation of the location data may include a coordinate, or a distance moved from an origin point, which may be defined at the point of activation of the cleaning appliance for cleaning the surface. Alternatively, the user may define, or redefine, the origin point manually. For example, the user may define the origin point when they begin to clean a first surface with the cleaning appliance and then redefine the origin point when they begin to clean a second, different, surface. In a practical example, this may occur as the user moves from room to room.

In a further example, the visual representation of the location data may include one or more colours for representing the location of the cleaning apparatus on the surface. In this case, a parameter of the colour may change as the location of the cleaning apparatus moves across the surface being cleaned. The parameter of the colour may comprise one or more of: opacity; hue; saturation; brightness; and the like. For example, where the visual representation of the location data includes a single colour, the colour may become more opaque, more saturated and/or brighter as the cleaning appliance passes over a given position on the surface being cleaned one or more times, meaning that an opaque, saturated and/or bright colour on the display may be indicative of a clean area of the surface. Alternatively, again where the visual representation of the location data includes a single colour, the colour may become less opaque, less saturated and/or darker as the cleaning appliance passes over a given position on the surface being cleaned one or more times, meaning that a translucent, unsaturated and/or dark colour on the display may be indicative of a clean area of the surface. In a further example, where the visual representation of the location data includes multiple colours, the hue of the colour may change as the cleaning appliance passes over a given position on the surface being cleaned one or more times, meaning that a given colour, which may be predetermined or set by the user, may be indicative of a clean area of the surface.

In a further example, the visual representation of the location data may include a visual pattern for representing the location of the cleaning apparatus on the surface. In this case, a parameter of the pattern may change as the location of the cleaning apparatus moves across the surface being cleaned. The parameter of the pattern may comprise one or more of: an opacity; a size; an orientation; a repetition of the pattern; a colour (which may include the sub-parameters of hue, brightness and saturation discussed above); and the like. For example, when the user initiates the cleaning appliance, the entire surface may be assigned a given pattern and as the cleaning appliance moves across the surface to clean the surface, the pattern may change or be removed. In a specific example, the visual representation of the location data may show a pattern fading (i.e., reducing in opacity) as the cleaning device moves over a given location one or more times.

As described above, where the system further comprises a camera to capture video data of the surroundings of the cleaning appliance, the visual representation of the location information, such as those visual representations discussed above, may be superimposed onto the captured video data.

Taking the example of a vacuum cleaner as a cleaning appliance for cleaning a floor, the camera may be mounted such that the field of view of the camera includes the cleaning head of the vacuum cleaner and at least the immediate surrounding of the cleaning head. The field of view and the focal length of the lens of the camera may be selected according to the cleaning appliance being used and the surface being cleaned. The display component may be mounted in a position that can be easily viewed by the user, such as near the handle of the cleaning appliance.

When the vacuum cleaner is first initialized in preparation for cleaning the surface, the display component may show the video data being captured by the camera and the visual representation of the location data superimposed thereon. In a particular example, the location data may be a colour or pattern to indicate where the cleaning head of the vacuum cleaner has been in contact with the surface being cleaned. In such an example, when the vacuum cleaner is first initialized in preparation for cleaning the surface, the display component may show only the captured video data. When the user then moves the vacuum cleaner across the surface to begin cleaning, the visual representation of the location data may be generated and superimposed on the captured video data as a coloured, or patterned, path showing where the cleaning head has been. In particular, at each point the camera captures video data of the surroundings of the cleaning apparatus, the location determination module may determine location data indicative of location of the portion of the surface which is being cleaned by the cleaning appliance at that given time and a visual representation (i.e., a colour or a pattern) may be generated and superimposed on the video data for display to the user. In this way, over time and as the cleaning appliance moves across the surface, the user will be presented with a tracked record of the positions occupied by the cleaning appliance since the cleaning process began.

Alternatively, when the vacuum cleaner is first initialized in preparation for cleaning the surface, the display component may show the captured video data with a colour or pattern layer provided over the entire surface to be cleaned. When the user then moves the vacuum cleaner across the surface to begin cleaning, the visual representation of the location data may be generated and superimposed on the captured video data as a clear path in the coloured or patterned layer showing where the cleaning head has been since the cleaning process began.

When cleaning a surface, particularly when cleaning a surface such as a carpet with a vacuum cleaner, it is often desirable to perform multiple passes over the surface with the cleaning appliance in order to ensure the surface has been cleaned sufficiently thoroughly. The present invention may provide a means of tracking multiple passes over a surface with the cleaning appliance as follows.

As described above, when the user then moves the vacuum cleaner across the surface to begin cleaning, the visual representation of the location data may be generated and superimposed on the captured video data as a coloured, or patterned, path showing where the cleaning head has been. The user may then move the vacuum cleaner such that the subsequent path of the cleaning head at least partially overlaps the initial path marked by the visual representation of the location data, for example by first pushing the vacuum cleaner away from themselves and then pulling the vacuum cleaner back along the same path. In this case, the visual representation of the location data in the overlapping region may be altered to indicate that the cleaning appliance has been passed over this region of the surface multiple times. For example, the visual representation of the location data may be a colour having an opacity of 208. Accordingly, on the first pass of the cleaning appliance over a portion of the surface, the visual representation will show a coloured path with a 20% opacity. When the user next moves the cleaning appliance over this region, such that the cleaning head of the cleaning appliance passes over the existing coloured path, the visual representation of this next pass of the cleaning appliance may simply be added onto the existing visual representation, meaning that there will be a portion of the visual representation having a 40% opacity indicated where two passes of the cleaning appliance have been performed. This may be repeated until 100% opacity of the visual representation is reached, which may indicate that the desired number of passes of the cleaning appliance has been fully achieved. In this example, the user may adjust the opacity of the visual representation in order to reflect the desired number of passes of the cleaning appliance to be achieved when cleaning the surface.

Alternatively, or in addition, to the opacity of the visual representation, any other suitable parameter of the visual representation may be adjusted with each pass of the cleaning appliance to indicate the number of passes performed by the cleaning appliance. For example, when the visual representation comprises a colour to be superimposed on the captured video data, multiple passes of the cleaning appliance over a portion of the surface may be indicated by an increase/decrease in saturation, a change in hue and/or an increase/decrease in brightness of the colour of the visual representation.

According to an aspect of the invention, the method may further comprise determining one or more operating characteristics of the cleaning appliance and generating instructions to cause the display component to display a visual representation of the operating characteristic of the cleaning appliance. Preferably, the one or more operating characteristics comprise one or more of: motor speed; mode of operation; stroke speed; speed of the cleaning appliance relative to the surface being cleaned; a multiple pass count; and data relating to particles collected by the cleaning appliance, which comprise one or more of: particle weight; particle size; and particle type. The visual representation of the operating characteristic of the cleaning appliance may be displayed by the display component in conjunction with the visual representation of the location information. For example, the visual representation of the operating characteristic of the cleaning appliance may be overlaid over the visual representation of the location information or displayed in a separate window on the display component. Alternatively, the visual representation of the operating characteristic of the cleaning appliance may be displayed on a separate display component to the display component showing the visual representation of the location information.

The optional features set out earlier, with respect to the nature of the visual representation of the location information, apply equally well to the second aspect of the invention.

The second aspect of the invention focuses on a method for tracking areas which have been cleaned using a cleaning appliance. A corresponding third aspect of the invention provides a computer program product comprising instructions which, when the program is executed by a computer, cause the computer to carry out the method steps described above with respect to the second aspect of the invention.

Further, a corresponding fourth aspect of the invention provides a computer-readable storage medium comprising instructions which, when executed by a computer, cause the computer to carry out the method steps described above with respect to the second aspect of the invention.

The invention includes the combination of the aspects and preferred features described except where such a combination is clearly impermissible or expressly avoided.

### BRIEF DESCRIPTION OF THE DRAWINGS

Embodiments of the present invention will now be described with reference to the accompanying drawings, in which:

FIG. 1A is a high-level system diagram including a mobile device and a cleaning appliance.

FIG. 1B shows a cleaning appliance, highlighting the example of a user operated vacuum cleaner as the cleaning appliance and a smartphone as the mobile device.

FIG. 2 is a schematic diagram showing the components of a mobile device.

FIG. 3 is a schematic diagram showing the components of a cleaning appliance.

FIG. 4 is a schematic diagram showing the components of the location determination module of the cleaning appliance or mobile device.

FIG. 5 is a schematic diagram showing the components of the sensor array of the cleaning appliance.

FIG. 6 is a flowchart illustrating, at a high-level, the steps which are performed by the system of the present invention.

FIGS. 7A, 7B, 7C and 7D are flowcharts illustrating the generation of the visual representation of the location information.

FIGS. 8A to 8E are schematic illustrations of examples of the visual representation of the location information that may be displayed to the user.

FIGS. 9A to 9C are schematic illustrations of how the visual representation of the location information may be overlayed onto captured video data.

### DETAILED DESCRIPTION OF THE DRAWINGS

Aspects and embodiments of the present invention will now be discussed with reference to the accompanying figures. Further aspects and embodiments will be apparent to those skilled in the art. All documents mentioned in this text are incorporated herein by reference.

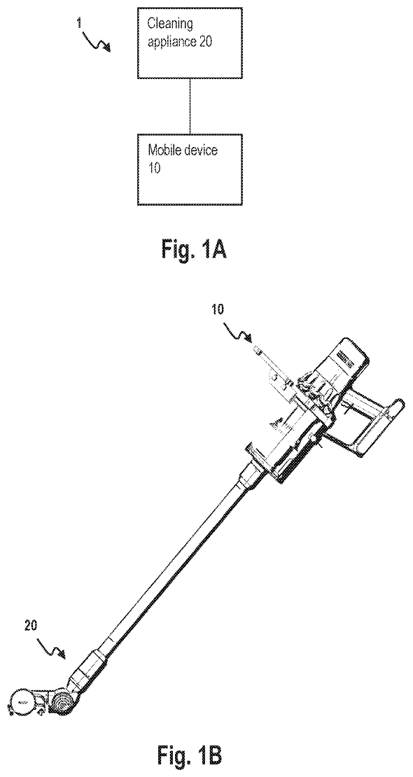

FIG. 1A is a high-level schematic of a system 1 which may be used to execute the method of the first aspect of the invention, for example. The system 1 includes up to three components: an optional mobile device 10 and a cleaning appliance 20. These components may be interconnected, as indicated by the lines connecting them. Specifically, mobile device 10 and the cleaning appliance 20 may be connected to each other via one or more networks (not shown), preferably wireless networks, such a Wi-Fi networks or cellular networks. In some cases, the three components may all be connected by the same network, and in other cases, each pair of components may be connected by a separate respective network. In other cases, two pairs of components may be connected by a first network, and the third pair of components may be connected by a second network. FIG. 1B shows an example of a cleaning appliance 20 and mobile device 10 which may be used in implementations of the present invention and will be discussed in more detail shortly.

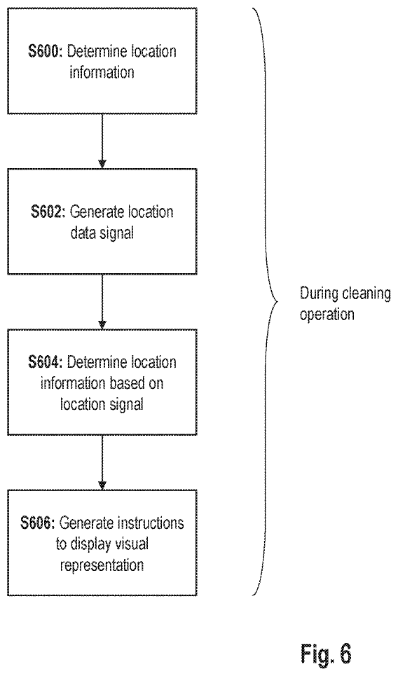

We now describe the components making up, respectively, the mobile device 10 and the cleaning appliance 20 with reference to FIGS. 1B to 5, before describing in detail the methods which may be performed by the respective components, with reference to FIGS. 6 to 9C.

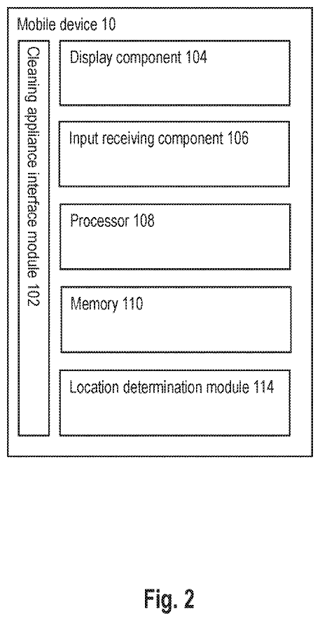

FIG. 2 shows an example of a mobile device 10 which may be used in methods according to the present invention. The mobile device 10 is preferably a handheld device such as a smartphone or tablet which has stored thereon an application which is configured to perform various aspects of the present invention. The mobile device 10 comprises a cleaning appliance interface module 102 for interfacing the with cleaning appliance. The mobile device 10 further comprises a display component 104, and input receiving component 106 (such as a touch screen, which may be integrated with the display component 104), a processor 108, and a memory 110. The mobile device further comprises a location determination module 114 configured to determine location information indicative of a location of a portion of a surface which is being cleaned by a cleaning appliance 20 at a given time. The functions of these components will be described in greater detail later in this application, with reference to the various methods which may be performed in accordance with the invention.

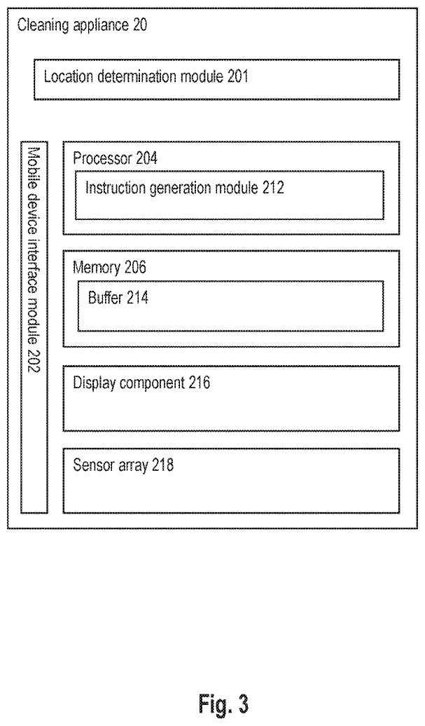

FIG. 3 is a schematic diagram of a cleaning appliance 20 which may be used in methods according to the present invention. In the case where the cleaning appliance is used in combination with the mobile device described above with respect to FIG. 2, the cleaning appliance 20 further includes a mobile device interface module 202 for interfacing with the mobile device 1.

In the case where no mobile device 10 is used in conjunction with the cleaning appliance, the cleaning appliance 20 itself may include a location determination module 201 configured to determine location information indicative of a location of a portion of a surface which is being cleaned by a cleaning appliance 20 at a given time. The cleaning appliance 20 would also comprise a processor 204 including an instruction generation module 210 whose purpose it is to receive the location data signal from the location determination module and to generate instructions configured to cause a display component 216 to display a visual representation of the location information contained in the location data signal. The functionality of these modules is described in detail later in this application.

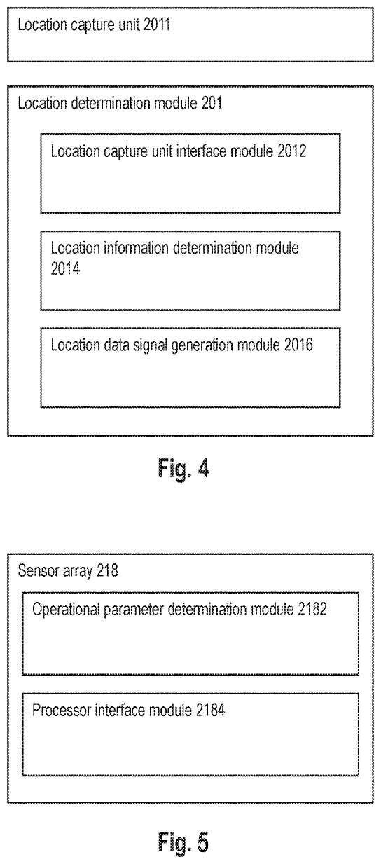

FIG. 4 shows a detailed schematic representation of the location determination module 201 of FIG. 3, which may also correspond to the location determination module 114 of FIG. 2, and a location capture unit 2011. The location capture unit 2011 is the unit, sensor or module that captures data relating to the surroundings of the cleaning appliance, which may then be interpreted by the location determination module to determine location information indicative of a location of a portion of a surface which is being cleaned by a cleaning appliance at a given time. For example, the location capture unit may comprise one or more of: a camera configured to capture video data as described above; a LiDAR unit configured to capture mapping data as described above; and an IMU unit configured to capture IMU data as described above. The location determination module 201 may then determine the location data based on the captured video data, captured mapping data and/or the captured IMU data. The location determination module may receive the captured video data, captured mapping data and/or the captured IMU data at a location capture unit interface module 2012. The location information is then be determined from the captured data by the location information determination module 2014 and a location data signal, to be sent to the processor 204, is generated by the location data signal generation module 2016.

Returning to FIG. 3, the cleaning appliance may further comprise a sensor array 218 for determining an operating parameter of the cleaning apparatus. The sensor array may comprise any of the sensors described above. The operating parameters of the cleaning appliance are determined by the operational parameter determination module 2182, which may then be provided to the processor 204, by way of the processor interface module 2184, so that the processor can generate instructions, by way of the instruction generating module 212, to cause the display component to display a visual representation of the operational parameter.

Returning once more to FIG. 3, the robotic vacuum cleaner 20 further includes a memory 206 which includes a buffer 2014.

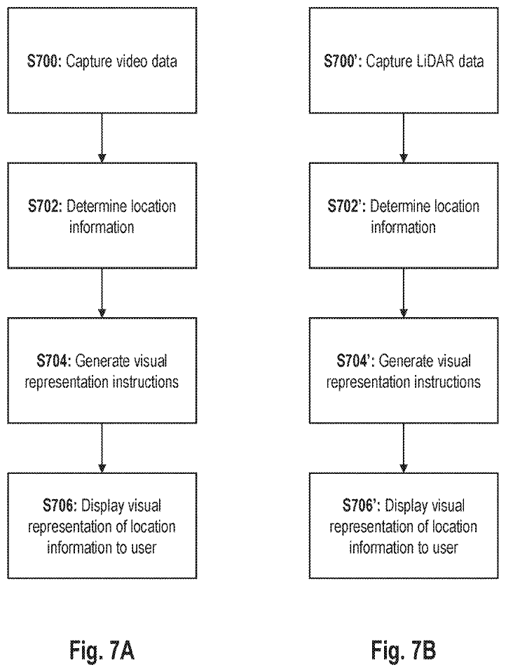

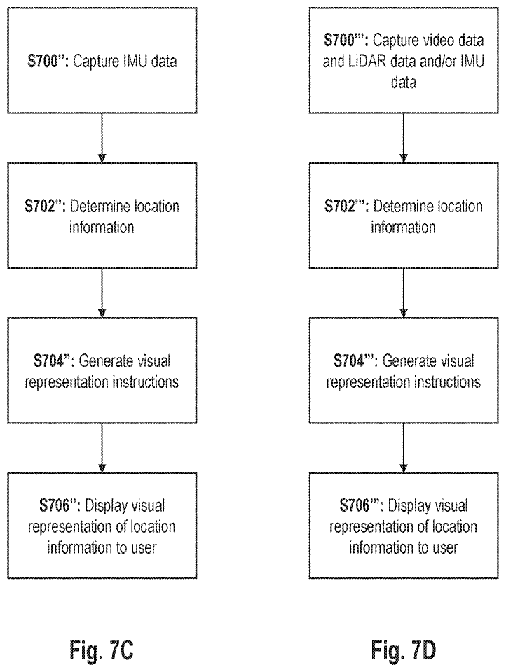

We now describe in detail methods which may be performed according to some aspects of the invention. FIG. 6 is a flowchart illustrating the high-level steps performed by the systems described above, and in particular the location determination module and processor of the cleaning appliance 20 or the mobile device 10. Steps S600 to S606 take place during a cleaning operation of the cleaning appliance 20, for example while the user is using a vacuum cleaner to vacuum the floor of a house or other building according to some cleaning plan. In step S600, location information indicative of a location of a portion of a surface which is being cleaned by a cleaning appliance at a given time is determined by way of a location determination module. In step S602, a location data signal encoding the location information is generated by said location determination module. The location data signal is then sent to a processor (step not shown) and in step S604, the location information is determined based on the location data signal by the processor. In step S606 instructions configured to cause a display component to display a visual representation of the location information are generated by the processor. The instructions may then be sent to a display component so the visual representation may be viewed by the user. The methods by which this may be performed are described now, with reference to FIGS. 7A, 7B, 7C and 7D.

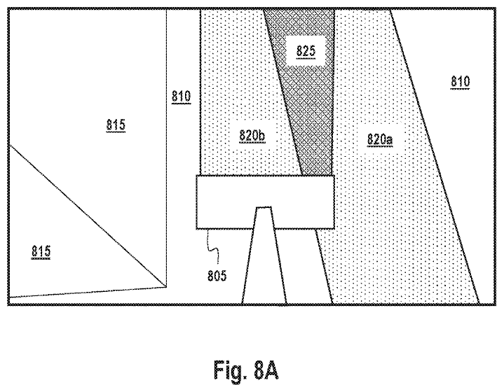

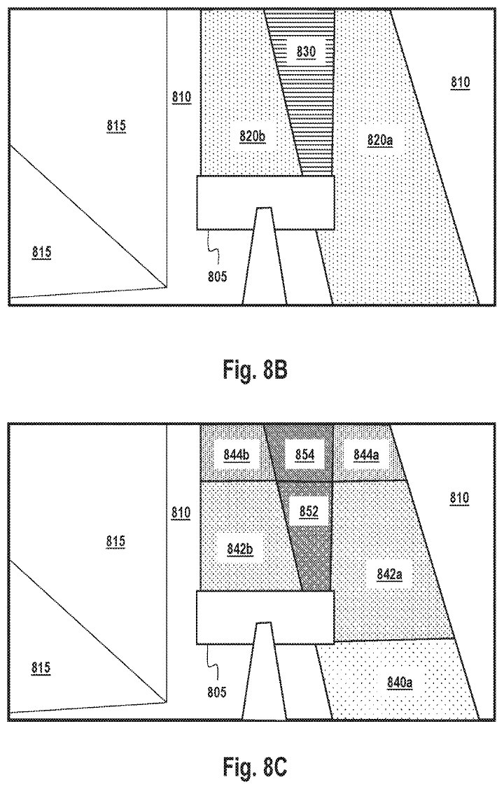

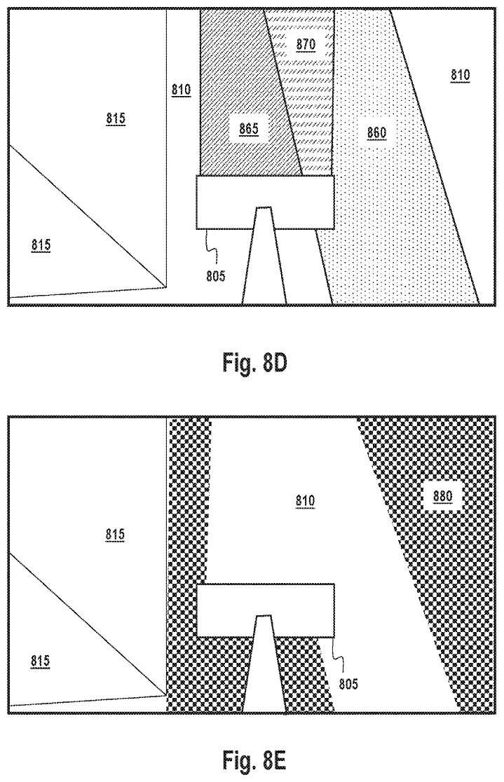

FIG. 7A is a flowchart illustrating the steps performed by the systems described above when generating the visual representation of the location information. In particular, the example shown in FIG. 7A shows the method for generating the visual representation of the location information when the system comprises a camera. For example, the system may comprise a cleaning appliance 20 and a mobile device 10 mounted thereto as shown in FIG. 2, wherein the mobile device is a smartphone with a camera. In step S700, the camera captures video data of the surroundings of the cleaning appliance. The camera may operate as described above. In step S702, the captured video data may be used to determine location information indicative of a location of a portion of a surface which is being cleaned by a cleaning appliance at a given time. For example, the captured video data may be received by a processor of the mobile device, which may then apply various image recognition and/or image processing algorithms to the captured video data in order to determine location information indicative of a location of a portion of a surface which is being cleaned by a cleaning appliance at a given time. For instance, captured video data may include the cleaning head of the cleaning appliance, in which case, the known distance between the camera and the cleaning head may be used to interpret the distance between the cleaning head and other objects or surfaces in the field of view of the camera. In step S704, instructions configured to cause a display component, such as a screen of the mobile device, to display a visual representation of the location information are generated by the processor. The instructions may be generated in order to cause the visual representation of the location information to be displayed as discussed above. In step S706, the instructions are sent to the display component in order to display the visual representation of the location information to the user. The visual representation of the location information may be displayed as discussed above. Further discussion on the displaying of the visual representation of the location information is provided below with reference to FIGS. 8A to 8E.

FIGS. 7B and 7C are identical to FIG. 7A apart from the fact that the captured data is captured LiDAR data and captured IMU data, respectively. In each respective case, the LiDAR data and the IMU data may be captured and interpreted as discussed above. FIG. 7D is identical to FIG. 7A apart from the fact that, in addition to the captured video data from a camera of the system, the system further comprises a LiDAR unit and/or an IMU unit to captured LiDAR data and/or IMU data, respectively. The LiDAR data and/or IMU data may be combined with the captured video data in order to determine the location information as discussed above. The camera, LiDAR unit and IMU unit may be located at any point in the system. For example, the camera and the IMU unit may be incorporated into a mobile device, such as a smartphone, and the LiDAR unit may be incorporated directly into the cleaning appliance at the cleaning head.

FIGS. 8A to 8E show schematic illustrations of the visual representation of the location information according to various aspect of the invention. The systems described above may be adapted to utilize any or all of the various visual representations described herein. As discussed above, the visual representation of the location data may take different forms according to various aspects of the invention.

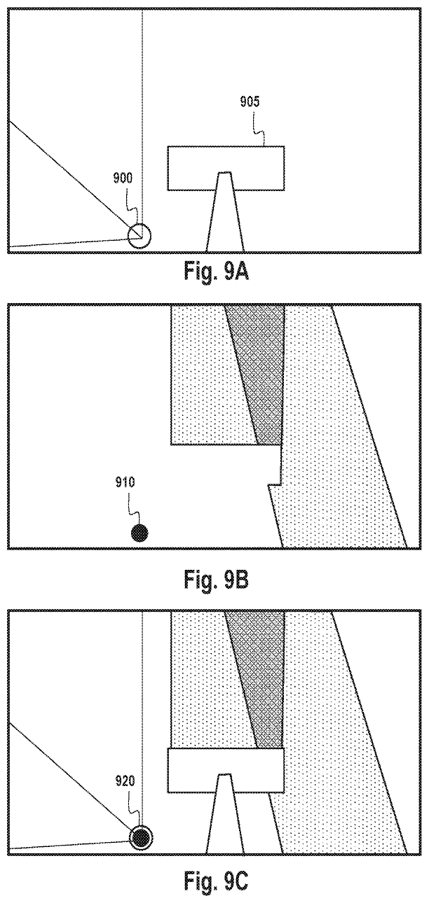

FIG. 8A shows a schematic illustration of the field of view of a camera capturing the video data, such as the field of view of mobile device 10 mounted to a cleaning appliance 20 as shown in FIG. 2, with the visual representation of the location information overlaid thereon. The overlaying of the visual representation of the location information on the captured video data is described in further detail below with respect to FIGS. 9A to 9C.

In the example shown in FIG. 8A, the depicted field of view includes the cleaning head 805 of the cleaning appliance, a floor surface 810, which is the surface being cleaned, and wall surfaces 815. In addition, FIG. 8A shows the visual representation of the location information as a tracked position of the cleaning head of the cleaning apparatus over time in the form of areas 820a, 820b and 825, which represent an area of a single pass of the cleaning head and an area of multiple passes, specifically two passes, of the cleaning head, respectively. Whilst the current field of view is displayed to the user, the full extent of the visual representation may not fit into the field of view visible to the camera, for instance, when the surface being cleaned is the floor of a large room. However, the visual representation, for example the tracked location of the cleaning head on the surface, may be persistent outside of the current field of view such that when a given area that has been cleaned re-enters the field of view of the camera, the visual representation previously generated for said area is shown on the display component. In the particular example shown in FIG. 8A, the visual representation of the location information comprises a coloured track overlaid on the captured video data to represent where the cleaning head of the cleaning appliance has been since it began cleaning the surface. As discussed above, a parameter of the colour may change as the location of the cleaning apparatus moves across the surface being cleaned. The parameter of the colour may comprise one or more of: opacity; hue; saturation; brightness; and the like. For example, where the visual representation of the location data includes a single colour, the colour may become more opaque, more saturated and/or brighter as the cleaning appliance passes over a given position on the surface being cleaned one or more times, meaning that an opaque, saturated and/or bright colour on the display may be indicative of a clean area of the surface. Alternatively, again where the visual representation of the location data includes a single colour, the colour may become less opaque, less saturated and/or darker as the cleaning appliance passes over a given position on the surface being cleaned one or more times, meaning that a translucent, unsaturated and/or dark colour on the display may be indicative of a clean area of the surface. In a further example, where the visual representation of the location data includes multiple colours, the hue of the colour may change as the cleaning appliance passes over a given position on the surface being cleaned one or more times, meaning that a given colour, which may be predetermined or set by the user, may be indicative of a clean area of the surface.

Returning to the particular example shown in FIG. 8A, the user has initiated the cleaning appliance and performed two movements of the cleaning head 805 over the floor surface 810. In the first movement, the user has pushed the cleaning appliance to define a first area 820a of the visual representation. In the second movement, the user has pulled the cleaning appliance to define a second area 820b of the visual representation. For example, the visual representation of the location information may be the colour blue with an opacity of 20%, meaning that the areas 820a and 820b will be blue tracks with an opacity of 20%, illustrating where the cleaning head 805 has passed over the floor surface 810 being cleaned. When performing the second movement, the user has moved the cleaning head 805 over part of the first area 820a, thereby forming an overlapping region 825 between the two areas. The overlapping region has had multiple passes of the cleaning head 805, whereas the areas 820a and 820b have only had a single pass of the cleaning head. In the example of FIG. 8A, the overlapping region 825 will simply have the visual representation of the location information compounded, meaning that the overlapping region will be shown as the colour blue with an opacity of 408. The compounding of the visual representations in overlapping regions such as 825 need not be linear. For example, the overlapping region may be shown as the colour blue with an opacity of 30% for two passes, 35% for three passes and so on.

FIG. 8B illustrates an example of the visual representation of the location information that is identical to FIG. 8A, apart from the fact that the overlapping region 830 is shown in a different colour to the areas 820a and 820b. For example, areas 820a and 820b may be shown in the colour blue with an opacity of 20% and the overlapping region may be shown in the colour orange with an opacity of 20%.

FIG. 8C illustrates an example of the visual representation of the location information that is identical to FIG. 8A, apart from the fact that the visual representation of the location information is divided into subregions based on an operating parameter of the cleaning appliance when the cleaning head 805 was present in said subregions. For example, the operating parameter may a detected particle amount in a given subregion, which may be indicative of a particular subregion containing larger amounts of dirt than the other subregions. In the particular example of FIG. 8C, the first area is divided into subregions 840a, 842a and 844a, the second area is divided into subregions 842b and 844b and the overlapping region is divided into subregions 852 and 854. In the particular example shown in FIG. 8C, the visual representation comprises: the colour green with an opacity of 20% for subregions having a low amount of dirt; the colour orange with an opacity of 20% for subregions having a medium amount of dirt; and the colour red with an opacity of 20% for subregions having a high amount of dirt. The term “low amount of direct” may be understood to mean a measured particle amount/size below a predetermined lower threshold. The term “medium amount of direct” may be understood to mean a measured particle amount/size between the predetermined lower threshold and a predetermined upper threshold. The term “high amount of direct” may be understood to mean a measured particle amount/size above a predetermined upper threshold. The thresholds may be set by the manufacturer, by the user or automatically set and adjusted by the system according to a learned cleaning routine performed using the cleaning appliance. Looking to FIG. 8C, the subregion 840a is a subregion having a low amount of dirt and so may be shown as a green area with an opacity of 20%. The subregions 842a and 842b are subregions having a medium amount of dirt and so may be shown as an orange area with an opacity of 20% and the corresponding overlapping region 852 may have an orange colour with an opacity of 408. The subregions 844a and 844b are subregions having a medium amount of dirt and so may be shown as a red area with an opacity of 20% and the corresponding overlapping region 854 may have a red colour with an opacity of 40%.

FIG. 8D illustrates an example of the visual representation of the location information that is identical to FIG. 8A, apart from the fact that the visual representation of the location information changes according to an operational mode of the cleaning appliance. For example, if the cleaning appliance was a wet and dry vacuum cleaner, the cleaning appliance may have a first, dry, cleaning mode and a second, wet, cleaning mode. In the particular example shown in FIG. 8D, the visual representation comprises a first area 860 indicative of where the cleaning head 805 moved when the cleaning appliance was in a first cleaning mode and a second area 865 indicative of where the cleaning head 805 moved when the cleaning appliance was in a second cleaning mode. For example, the first area may have a blue colour and the second area may have a red colour. The overlapping region 870, which may for example have a purple colour, is indicative of an area of the surface that has been subjected to both the first and second cleaning modes.

FIG. 8E illustrates an example of the visual representation of the location information that is identical to FIG. 8A, apart from the fact that the visual representation of the location information comprises a colour or pattern layer 880 provided over the entire floor surface 810 to be cleaned. When the user then moves the vacuum cleaner across the surface to begin cleaning, the visual representation of the location data may be generated and superimposed on the captured video data as a clear path in the coloured or patterned layer showing where the cleaning head has been since the cleaning process began. Put another way, as the user moves the cleaning head 805 over the surface 810, the colour or pattern layer 880 may be fully, or partially, removed from the displayed image shown to the user. In this way, the user may effect full cleaning of the surface by “removing” all of the coloured or patterned layer.

FIGS. 9A to 9C show a schematic illustration demonstrating the overlaying of the visual representation of the location information onto the captured video data. FIG. 9A shows a schematic illustration of the field of view of a camera capturing the video data, such as the field of view of mobile device 10 shown in FIG. 2. The depicted field of view includes a first locus 900 and the cleaning head 905 of the cleaning appliance. FIG. 9B shows a schematic illustration of the visual representation of the location information of the cleaning appliance, which may have been generated as described above. The visual representation of the location information of the cleaning appliance includes a second locus 910, which corresponds to the same real space location as the first locus 900. FIG. 9C shows a schematic illustration of the visual representation of the location information of the cleaning appliance (shown in FIG. 9B) overlaid onto the captured video data (shown in FIG. 9C) such that the first locus 900 and the second locus 910 overlap each other.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

1. A system configured to track areas which have been cleaned using a cleaning appliance, the system comprising:
a location determination module;
a processor; and
a display component, wherein:
the location determination module is configured to determine location information indicative of a location of a portion of a surface which is being cleaned by a cleaning appliance at a given time; and to generate a location data signal encoding the location information; and
the processor is configured to receive the location data signal from the location determination module and to determine, based on the location data signal, the location information; and to generate instructions configured to cause a display component to display a visual representation of the location information.

2. The system of claim 1, wherein:
the location determination module is configured to determine the location information at predetermined time intervals.

3. The system of claim 1, wherein:
the instructions are configured to cause the display component to display the visual representation of the location information in real-time.

4. The system of claim 1, wherein:
the system further comprises a camera configured to capture video data of its surroundings; and
the location determination module is configured to determine the location information based on at least the captured video data.

5. The system of claim 4, wherein:
the display component is configured to display the captured video data; and
the instructions are configured to cause display component to superimpose the visual representation of the location information over the display of the captured video data, such that each locus of the visual representation of the location information is superimposed on the corresponding locus of the captured video data.

6. The system of claim 1, wherein:
the system further comprises a light detection and ranging (LiDAR) unit configured to capture mapping data of its surroundings; and
the location determination module is configured to determine the location information based on at least the captured mapping data.

7. The system of claim 1, wherein:
the system further comprises an inertial measurement unit (IMU) configured to detect changes in motion and orientation of the cleaning appliance and to generate IMU data in response to the detection; and
the location determination module is configured to determine the location information based on at least the IMU data.

8. The system of claim 1, wherein:
the cleaning appliance comprises a cleaning component which defines the portion of the surface being cleaned at any given time; and
the location determination module is configured to determine the location of the cleaning component within its surroundings, and to generate the location information based on the location of the cleaning component within its surroundings.

9. The system of claim 1, wherein:
the processor is configured to determine one or more operating characteristics of the cleaning appliance;
the instructions are further configured to cause the display a visual representation of the operating characteristic of the cleaning appliance.

10. The system of claim 1, wherein:
the one or more operating characteristics comprise one or more of: motor speed; mode of operation; stroke speed; speed of the cleaning appliance relative to the surface being cleaned; a multiple pass count; and data relating to particles collected by the cleaning appliance, which comprise one or more of: particle weight; particle size; and particle type.

11. The system of claim 1, further comprising a mobile device comprising:
the location determination module;
the processor; and
the display component.

12. The system of claim 11, wherein:
the system further comprises the cleaning appliance; and
the mobile device is mountable on the cleaning appliance.

13. The system of claim 1, further comprising the cleaning appliance comprising:
the location determination module;
the processor; and
the display component.

14. The system of claim 1, wherein the cleaning appliance is a surface-cleaning appliance.

15. The system of claim 14, wherein the floor-cleaning appliance is a vacuum cleaner, a wet vacuum cleaner, a dry and wet vacuum cleaner, a polisher, a steam cleaner, a hard surface cleaner or a carpet cleaner.

16. A method for tracking areas which have been cleaned using a cleaning appliance, the method comprising:
determining, by a location determination module, location information indicative of a location of a portion of a surface which is being cleaned by a cleaning appliance at a given time;
generating a location data signal encoding the location information;
determining, by a processor, the location information based on the location data signal; and
generating instructions configured to cause a display component to display a visual representation of the location information.
